(19) United States
(12) Patent Application Publication
(10) Pub. No.: US 2011/0000922 A1
(43) Pub. Date: Jan. 6, 2011

(54) PRESSURIZED CONTAINER ARRANGEMENT WITH A COMPENSATION BELLOWS

(75) Inventors: Dirk Barz, Marloffstein (DE); Thomas Hagen, Erlangen (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Muenchen (DE)

(21) Appl. No.: 12/918,886

(22) PCT Filed: Feb. 17, 2009
(86) PCT No.: PCT/EP2009/051824

§ 371 Date: Aug. 23, 2010

(30) Foreign Application Priority Data
Feb. 22, 2008 (DE) 10 2008 011 042.6

(51) Int. Cl. F17C 1/00

(52) U.S. Cl. 220/581

(57) ABSTRACT

A pressurized container assembly includes a first coupling member and a second coupling member. The two coupling members can be moved relative to one another. A compensation bellows is mounted to seal a telescoping support assembly between the two coupling members.

The invention relates to a pressurized container assembly with a deformable compensation bellows which allows a relative movement between a first and a second coupling point of the pressurized container assembly.

By way of example, one such pressurized container assembly is known from laid-open specification DE 35 46 011 A1. There, a plurality of compensation bellows are arranged with their respective coupling points located one behind the other, in order to compensate for relatively major length changes of housings connected in between.

A pressurized container assembly such as this is relatively costly to manufacture since a multiplicity of coupling points, compensation bellows and housings must be used. This results in a multiplicity of sealing points, which must be appropriately sealed during the assembly process, and should provide a permanent seal.

The object of the invention is therefore to refine a pressurized container assembly of the type mentioned initially such that greater compensation travels can be achieved by a simplified pressurized container assembly.

According to the invention, in the case of a pressurized container assembly of the type mentioned initially, the object is achieved in that the compensation bellows seals a supporting assembly between the first coupling point and the second coupling point.

A supporting assembly makes it possible to equip the pressurized container assembly with adequate mechanical resistance. The two coupling points can communicate with one another via a supporting assembly, thus ensuring a specific relative position between them.

It is also advantageously possible for the supporting assembly to be telescopic.

Telescoping allows different assemblies of the supporting assembly to slide into one another. This ensures a dielectrically advantageous external contour of the supporting assembly, irrespective of the position of the coupling points with respect to one another. The compensation bellows allows appropriate sealing of the telescopic supporting assembly.

In this case, for example, it is advantageously possible for the compensation bellows to surround at least one cylindrical section of the supporting assembly.

By way of example, the supporting assembly can provide a cylindrical section which allows the supporting assembly to be telescopic. The length to be covered by the compensation bellows can be limited by arranging the compensation bellows around the cylindrical section. For example, it is possible for parts of the supporting assembly to be a component of encapsulation of the pressurized container assembly. The cylindrical section can be arranged on a piston, which slides in a cylinder, or can be arranged on a cylinder, which holds a piston.

A further advantageous refinement makes it possible for the compensation bellows to surround the cylindrical section and the piston section of the telescopic supporting assembly.

If the compensation bellows surrounds at least a part of the cylindrical section and a part of the piston section, this increases the length change which can be provided by means of the pressurized container assembly, in particular between the coupling points. This admittedly requires a compensation bellows of generous design, but allows a greater compensation travel to be achieved with a single compensation bellows. Particularly when the pressurized container assembly is arranged in regions where the climate is problematic, that is to say in regions with very high or very low temperatures and correspondingly major temperature fluctuations, it is therefore possible in this way to cope with relatively major length changes of the pressurized container assembly. For example, the lengths of assemblies adjacent to the first and/or to the second coupling point can be varied without mechanical stresses which could possibly lead to irreparable damage occurring throughout the assembly.

It is advantageously also possible for the supporting assembly in the compensation bellows to make electrically conductive contact with one another.

An electrically conductive contact between the compensation bellows and the supporting assembly means that these components are at the same electrical potential. The creation of discharge phenomena or the like between them is therefore improbable. For example, it is possible for the supporting assembly and/or the compensation bellows to be parts of encapsulation of the pressurized container assembly. The functions are therefore split between the compensation bellows and the supporting assembly. The supporting assembly is used for mechanical retention and robustness of the pressurized container assembly, whereas the compensation bellows, which may intrinsically be flexible and not robust, is used for fluid-tight compartmentalization of the pressurized container assembly.

Furthermore, it is advantageously possible for the supporting assembly and the compensation bellows to be electrically isolated from one another.

Electrical isolation of the supporting assembly and compensation bellows allows an electrically insulating medium to be arranged between these assemblies, and allows the pressurized container assembly to be used, for example, for electrical power transmission. In this case, the supporting assembly is part of an electrical conductor run, for example a so-called busbar, which is used for carrying, guiding and conducting an electric current, while the compensation bellows forms a part of encapsulation of the pressurized container assembly. In addition to making the encapsulation fluid-tight, the compensation bellows can also be used to provide direct-contact protection for the supporting assembly.

In this case, it is also advantageously possible for the supporting assembly to have an electrically isolating supporting element aligned radially with respect to its telescoping axis.

An electrically isolating supporting element, for example a disk insulator, a post insulator or an assembly with an electrical isolation point, can ensure that the compensation bellows or other pressurized container assemblies is or are at a distance from the supporting assembly. Electrical isolation prevents potentials from flashing over between the supporting assembly and a further assembly. In this case, the compensation bellows can be supported directly via the electrically isolating supporting element. However, it is also possible for it to be supported only indirectly via an intermediate assembly of the pressurized container assembly.

A further advantageous refinement allows the cylindrical section and the piston section to engage in one another via a sealing element.

The supporting device with a cylindrical section and a piston section which engage in one another is used for a refinement of an assembly whose length is variable in the insertion direction of the piston. This ensures that the cylindrical section and the piston section can move axially with respect to one another. Radial forces can be absorbed by the supporting assembly. The assembly of a sealing element, for example of a plastic fitting or the like, allows the response of the supporting assembly, in respect of its axial capability, to be adjusted. For example, it is thus possible for length compensation with relative free movement or with relatively hard movement to be desirable, depending on the application area of the pressurized container assembly. Furthermore, the sealing element makes it possible to prevent tilting and/or blocking of the cylindrical section and piston section with respect to one another.

In this case, it is advantageously possible for the cylindrical section and the piston section to make electrically conductive contact via a contact assembly.

A contact assembly allows the cylindrical section and the piston section to make electrically conductive contact with one another. If a corresponding potential is intended to be applied to the supporting device, and this potential is also intended to be transmitted via the pressurized container assembly, electrical contact between the assemblies of the supporting device may be advantageous. By way of example, flexible current strips or the like can be used to make contact. For example, it is possible to provide an electrical conductor run for transmission of electrical power (a so-called busbar) in the form of a supporting element, and for electrical power to be passed on via this element. Alternatively, when the supporting device is used as part of a housing of the pressurized container assembly, it is advantageous to provide a defined potential of all assemblies. By way of example, this defined potential may be a ground potential, as a result of which it is virtually impossible for voltages and potential differences to be passed on on the encapsulation of the pressurized container assembly. The encapsulation of the pressurized container assembly can therefore also be used as direct-contact protection for a component which is arranged in the interior, for example a component such as a busbar which is at high voltage.

It is advantageously possible for the contact assembly to be a sliding contact assembly.

By way of example, a sliding contact assembly can be provided in the area of the piston/cylinder sections, in which it can be expected that the cylindrical section and piston section will be covered all the time. If required, this sliding contact assembly can be designed in combination with a sealing element. By way of example, contact fingers, spirals springs, contact laminates or sliding contact assemblies shaped in some other way may be used as a sliding contact assembly.

Furthermore, one advantageous refinement allows at least one of the coupling points to have a flange.

Coupling points in the pressurized container assembly are used to advantageously insert the pressurized container assembly into an overall assembly. Further assemblies are fitted to the coupling points, such that the pressurized container assembly can also advantageously compensate for length changes originating from these fitted assemblies. In this case, the coupling points may be designed in widely differing forms. In this case, it is necessary that they can be used as flexibly as possible. For example, the coupling points may be in the form of a flange, such that the pressurized container assembly can be attached to appropriate mating flanges. In this case, the flange can be part of the encapsulating housing, and should be able to form a fluid-tight connection, in particular a gas-tight connection to adjacent assemblies. By way of example, screw flanges or other flange assemblies can be used as flanges.

The coupling points are fixed in their position relative to one another via the supporting assembly and, depending on the configuration of the supporting assembly, only specific relative movements can be carried out between the coupling points. This movement should advantageously be a linear movement along an axis which extends between the coupling points. Depending on the configuration of the supporting device and its piston and/or cylinder sections, slight radial offsets between the coupling points can also be compensated for, if necessary.

A further advantageous refinement allows the pressurized container assembly to be fluid-tight.

The pressurized container assembly has encapsulation which surrounds components arranged in the interior of the pressurized container assembly, and protects them against external influences. The interior of the pressurized container assembly can in this case be filled with a specific medium, bounded by the encapsulation. This medium may, for example, be a fluid, in particular a gas. In this case, the encapsulation prevents the medium from emerging in an uncoordinated manner from the pressurized container assembly, and from evaporating. In this case, the encapsulation for the pressurized container assembly is designed such that it withstands corresponding pressure from the medium arranged in the interior of the pressurized container.

It is advantageously also possible for the pressurized container assembly to be part of an electrical power transmission device.

Electrical power transmission devices normally have an electrical conductor run which must be arranged such that it is isolated from other assemblies. The electrical conductor run may, if required, be designed to be switchable, or contain distribution assemblies, etc. The pressurized container assembly now allows electrically stable isolation of electrical conductor runs arranged in the interior of the pressurized container. In this case, fluid media are arranged within encapsulation on the pressurized container assembly, thus resulting in adequate electrical isolation between the assemblies arranged in the interior of the pressurized container assembly and the encapsulation on the pressurized container assembly. Fluid isolating media are advantageously able to autonomously close a passage channel, after such a passage channel has been formed. In particular, the use of insulating oils and insulating gases has been proven. By way of example, nitrogen, sulfurhexafluoride or other electrically insulating gases can be used as insulating gases. When an increased pressure is appropriately applied to the fluids, in particular the gases, the dielectric strength of these media can additionally be reinforced, thereby allowing a more compact configuration of electrical power transmission devices. By way of example, electrical power transmission devices are cables, gas-insulated pipelines, gas-insulated switchgear assemblies, gas-insulated switching devices such as circuit breakers, isolating switches, grounding switches, surge arresters, instrument transformers, etc.

Exemplary embodiments of the invention will be described in more detail in the following text, and are illustrated schematically in the drawing, in which:

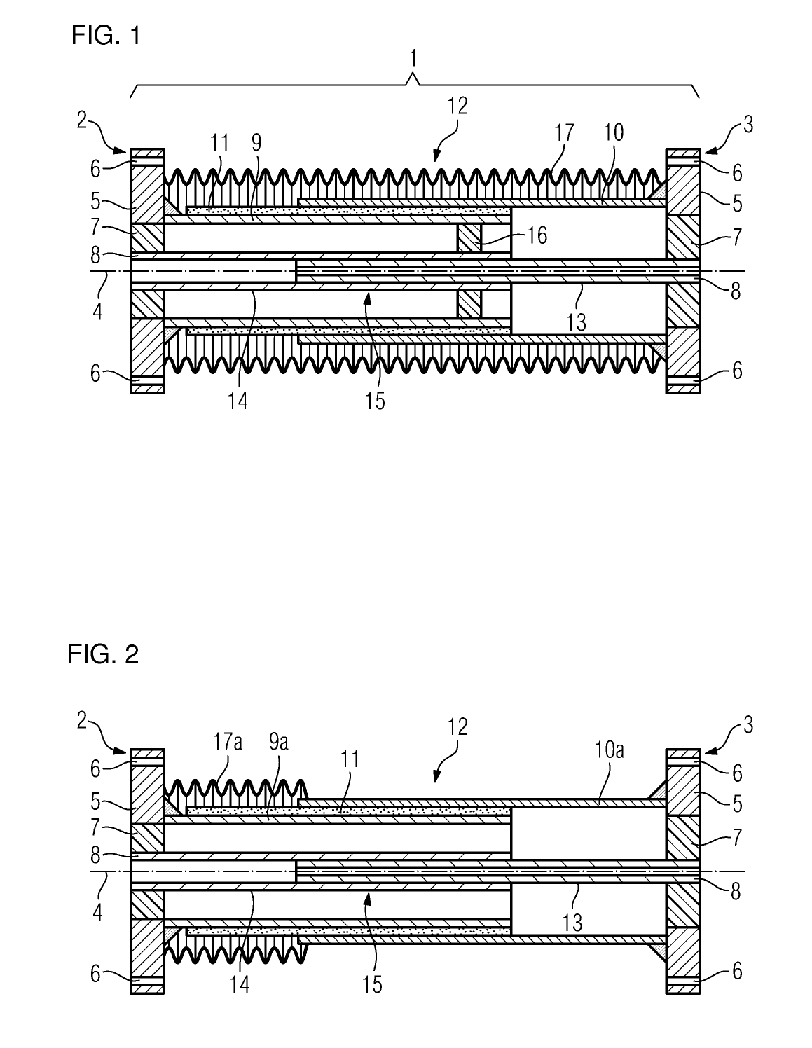

FIG. 1 shows a section through a pressurized container assembly with a compensation bellows which surrounds a cylindrical section and a piston section of a supporting assembly, and

FIG. 2 shows a pressurized container assembly with a compensation bellows which surrounds a cylindrical section of a supporting assembly.

FIG. 1 shows a pressurized container assembly 1 with a first coupling point 2 and a second coupling point 3. The pressurized container assembly 1 is intended to be used as part of a compressed-gas-insulated electrical power transmission assembly. For this purpose, the two coupling points 2, 3 are designed to be of the same type. By way of example, one embodiment of a coupling point will be described in the following text, with reference to the design of the first coupling point 2.

The first coupling point 2 has a disk-like structure. The first coupling point 2 is formed coaxially with respect to an axis of symmetry 4. The first coupling point 2 has a circular contour. The circular contour is formed by a metallic frame 5. The metallic frame 5 acts as a flange for the coupling point 2. In order to allow the metallic frame 5 to be connected to mating flange, it has recesses 6 which are distributed symmetrically on the circumference and through which bolts can be passed, allowing the first coupling point 2 to be braced to the mating flange.

An insulating body 7 is inserted into the metallic frame 5. The insulating body 7 is connected to the frame 5 in a fluid-tight manner. The insulating body 7 is used for concentrically holding an electrical conductor 8 which is intended to carry an electric current. The electrical conductor 8 in the present case is in the form of a tubular conductor. However, it is also possible for the electrical conductor 8 to be in the form of a solid conductor, at least in the area of the coupling point 2.

The metallic frame 5, the insulating body 7 and the electrical conductor 8 are connected to one another in a fluid-tight manner. It is therefore possible, for example, to prevent fluids from emerging or passing through the first coupling point 2, in an undesired manner. However, depending on the requirement, a recess can also be provided at the first coupling point 2, thus allowing fluids to pass deliberately through the first coupling point 2. By way of example, the insulating body 7 may have one or more recesses for this purpose. However, a recess in the electrical conductor 8 can allow fluids to cross over. The second coupling point 3 in principle is designed in the same way as the first coupling point 2. In addition to the configuration of the coupling points 2, 3 with a centrally arranged electrical conductor 8, a plurality of electrical conductors 8 can also be pass through the coupling points, in an electrically isolated form. For example, it is possible for this purpose to provide for the insulating body 7 to have an appropriate holding apparatus for a plurality of electrical conductors 8, or for the metallic frame 5 to have a plurality of recesses for holding a plurality of insulating bodies, which each hold one or more electrical conductors.

In order to form the pressurized container assembly 1, the first coupling point 2 and the second coupling point 3 are aligned approximately coaxially, with their disk shape being aligned as symmetrically as possible with respect to the axis of symmetry 4. In order to complete the pressurized container assembly 1, a first cylindrical housing section is arranged at the first coupling point 2 and acts as a piston section 9 of the housing. A further cylindrical housing section is arranged at the coupling point 3, and acts as a cylindrical section 10 of the housing. The piston section 9 and the cylindrical section 10 of the housing are designed such that an outer envelope surface of the piston section 9 engages with an accurate fit in the inner envelope surface of the cylindrical section 10 of the housing. If required, a sealant 11 is arranged between the outer envelope surface of the piston section 9 of the housing and the cylindrical section 10 of the housing. In the present case, the sealant 11 is applied to the outer envelope surface of the piston section 9 of the housing, and is used on the one hand to seal the piston section 9 of the housing from the cylindrical section 10 of the housing, and on the other hand this sealing 11 also has a friction-reducing effect, thus allowing easy relative movement of the piston section 9 of the housing and cylindrical section 10 of the housing along the axis of symmetry 4. The two coupling points 2, 3 are supported with respect to one another via the piston section 9 of the housing and the cylindrical section 10 of the housing, thus forming a telescopic first supporting assembly by means of the piston section 9 of the housing and the cylindrical section 10 of the housing.

A conductor run 13, which is arranged in the interior of the pressurized container assembly 1, is designed in a similar manner to the piston and cylindrical sections 9, 10 of the housing. The conductor run likewise has a piston section 13, which is formed coaxially with respect to the axis of symmetry 4. Furthermore, the conductor run has a cylindrical section 14. The piston section 13 and the cylindrical section 14 of the conductor run can move relative to one another in the direction of the axis of symmetry 4, and form a telescopic, second supporting assembly 15. In the same way as the first supporting assembly 12, the second supporting assembly 15 supports the two coupling points 2, 3 relative to one another and allows a longitudinal movement of the two coupling points 2, 3 with respect to the axis of symmetry 4. In addition to the piston section 13 and the cylindrical section 14 of the conductor run being in the form of tubes, it is also possible to use solid assemblies, which have a corresponding recess only in the area of their cover to form a cylinder.

Sliding contact assemblies are arranged in the area of the coverage of the piston section 13 and cylindrical section 14 and allow an electrical contact between the piston section 13 and the cylindrical section 14 of the conductor run. An electric current can therefore be passed through the conductor run independently of the relative position of the piston section 13 and cylindrical section 14 of the conductor run. In addition to using sliding contact assemblies, for example laminates which are circumferential in an annular shape, contact fingers or the like, it is also possible to use flexible conductor sections, which make an electrically conductive contact both with the piston section 13 and with the cylindrical section 14, and result in a contact point being bridged, with flexible deformation, during relative movement thereof.

In order to assist the supporting effects of the first supporting assembly 12 and the second supporting assembly 15, an electrically isolating supporting element 16, which is arranged radially with respect to the axis of symmetry 4, is provided between the two supporting assemblies. By way of example, the electrically isolating supporting element 16 can surround the conductor run 13, for example in the form of a disk, and can support the conductor run 13. The first supporting assembly 12 is therefore additionally stabilized with respect to the second supporting assembly 15, thus allowing easy relative movement between the first coupling point 2 and the second coupling point 3. The assemblies in the first supporting assembly 12 can be isolated, in terms of potential, from the assemblies in the second supporting assembly 15 by the use of an electrically isolating supporting element 16, for example composed of synthetic resin or the like. The conductor run can therefore be held in the interior, electrically isolated via the isolating body 7 from the electrical potential on the metallic frame 5, and can also be arranged such that it is electrically isolated from the assemblies of the housing.

In order to prevent electrical potentials from being spread onto the piston section 9 and cylindrical section 10 of the housing, the two assemblies can have the same potential applied to them. It has been found to be advantageous to use ground potential for this purpose. In order to make electrical contact, separate contact elements can accordingly be provided between the two piston sections 9 as well as the cylindrical section 10 of the housing. However, it is also possible for the sealing 11 to allow an adequate electrical contact between the two assemblies of the first supporting assembly 12, or for contact to be made via a compensation bellows 17.

A relative movement between the two coupling points 2, 3 also results in relative movements between the piston sections 9, 13 and cylindrical sections 10, 14. The sealant 11 prevents foreign substances from entering the interior of the pressurized container assembly, in which the conductor run is located. In order to ensure that the assembly is fluid-tight over relatively long time periods and with adequate quality, the compensation bellows 17 is provided, surrounding both the assemblies of the first supporting assembly 12 and those of the second supporting assembly 15. The compensation bellows 17 has an essentially channel-like structure, with the surface having a corrugated shape, as a result of which the compensation bellows 17 is reversibly deformable. At the points at which it makes contact with the coupling points 2, 3, the compensation bellows 17 has an annular structure. The compensation bellows 17 can be connected in a gas-tight manner to the metallic frame 5 of the coupling points 2, 3. For example, it is possible for the compensation bellows 17 to be integrally connected to the metallic frame 5. Welding and soldering processes are particularly suitable for this purpose.

Since the compensation bellows 17 covers the entire distance between the coupling points 2, 3, the overall assembly is protected against the ingress and emergence of fluids. It is therefore now possible to fill the interior of the pressurized container assembly with a pressurized gas. Encapsulation, which can be referred to as a fluid-tight barrier, is provided over the compensation bellows 17 between the metallic frames 5.

FIG. 2 shows a modification of the pressurized container assembly 1 shown in FIG. 1. The statements made with regard to FIG. 1 apply to the design of the coupling points 2, 3, to the relative movement capability of the coupling points 2, 3 with respect to the axis of symmetry 4, to the configuration of a first supporting assembly 12 and of a second supporting assembly 15. However, in contrast to the embodiment shown in FIG. 1, in the case of the exemplary embodiment of the pressurized container assembly shown in FIG. 2, no electrically isolating supporting element is used to assist the robustness of the first supporting assembly 12 and of the second supporting assembly 15. In order to form an adequate fluid-tight design and to reduce the dimensions of a folding bellows 17a, a cylindrical section 10a of the housing is in the form of part of fluid-tight encapsulation. The cylindrical section 10a of the housing is connected in a fluid-tight manner to the metallic frame 5 of the second coupling point 3. The compensation bellows 17a is connected in a fluid-tight manner to the metallic frame 5 of the first coupling point 2. In contrast to the example shown in FIG. 1, the compensation bellows 17a is connected in a fluid-tight manner to that end of the cylindrical section 10a of the housing which projects in the direction of the first coupling point 2. An integral joining process, preferably welding or soldering, can once again be carried out for this purpose. Encapsulation using the compensation bellows 17a and the fluid-tight characteristics of the cylindrical section 10a is now provided between the two metallic frames 5 of the first coupling point 2 and of the second coupling point 3. In this case, the compensation bellows 17a surrounds the piston section 9a of the pressurized container assembly. The compensation bellows 17a is electrically conductively connected via the metallic frame 5 and directly to the cylindrical section 10a and to the piston section 9a of the housing.

1-14. (canceled)

15. A pressurized container assembly, comprising:
a first coupling member and a second coupling member movably mounted relative to one another;
a supporting assembly between said first and second coupling members and enabling a relative movement between said first and second coupling members; and
a deformable compensation bellows allowing a relative movement between said first and second coupling members, said compensation bellows and sealing said supporting assembly between said first coupling member and said second coupling member.

16. The pressurized container assembly according to claim 15, wherein said supporting assembly is telescopic.

17. The pressurized container assembly according to claim 15, wherein said supporting assembly is formed with at least one cylindrical section and said compensation bellows surrounds said at least one cylindrical section of said supporting assembly.

18. The pressurized container assembly according to claim 15, wherein said supporting assembly is a telescopic supporting assembly with a cylindrical section and a piston section, and wherein said compensation bellows surrounds said cylindrical section and said piston section.

19. The pressurized container assembly according to claim 15, wherein said supporting assembly and said compensation bellows are disposed to make electrically conductive contact with one another.

20. The pressurized container assembly according to claim 15, wherein said supporting assembly and said compensation bellows are electrically isolated from one another.

21. The pressurized container assembly according to claim 15, wherein said supporting assembly has an electrically isolating supporting element aligned radially with respect to a telescoping axis thereof.

22. The pressurized container assembly according to claim 18, which further comprises a sealing element disposed such that said cylindrical section and said piston section engage in one another via said sealing element.

23. The pressurized container assembly according to claim 18, which further comprises a contact arrangement, and wherein said cylindrical section and said piston section make electrically conductive contact via said contact arrangement.

24. The pressurized container assembly according to claim 23, wherein said contact arrangement is a sliding contact arrangement.

25. The pressurized container assembly according to claim 15, wherein at least one of said first and second coupling members has a flange.

26. The pressurized container assembly according to claim 15, wherein said pressurized container assembly is fluid-tight.

27. The pressurized container assembly according to claim 15, wherein said compensation bellows forms a part of an encapsulation of the pressurized container assembly.

28. The pressurized container assembly according to claim 15, wherein said pressurized container assembly forms a part of an electrical power transmission device.
